(19) United States
(12) Patent Application Publication
(10) Pub. No.: US 2010/0198721 A1
(43) Pub. Date: Aug. 5, 2010

(54) Management of Dematerialized Safes

(76) Inventor: Laurent Caredda, Clermont-Ferrand (FR)

Correspondence Address: FROST BROWN TODD, LLC, 2200 PNC CENTER, 201 E. FIFTH STREET, CINCINNATI, OH, 45202, US

(21) Appl. No.: 12/670,510

(22) PCT Filed: Jul. 28, 2008
(86) PCT No.: PCT/FR08/51418

§ 371 Date: Jan. 25, 2010

(30) Foreign Application Priority Data
Jul. 27, 2007 (FR) 0756769

(51) Int. Cl. G06F 21/24; G06Q 40/00

(52) U.S. Cl. 705/39; 726/28

(57) ABSTRACT

The invention pertains to the management and sharing of dematerialised safes, and relates to a method for managing a secured storage space (C1) or dematerialised safe associated with a first user (U1), that comprises allocating for a predetermined portion (C1i) of said space access rights to a second user (AUi) so that said predetermined portion defines a secured exchange space between said first user and said second user. This exchange space is dedicated to exchanges between the first and second users and is accessible through a secured link upon the implementation of at least one transaction between the first and second users that implies the execution of at least a first action on the content of the first portion.

### FIELD OF THE INVENTION

The invention relates to the management of a dematerialised safe, which is to say a secured storage space of dematerialised contents.

### BACKGROUND OF THE INVENTION

At present, many documents, especially official documents, are changing to electronic formats. Given that certain documents must be conserved for periods of a certain length of time, dematerialised safe solutions, such as those proposed on www.e-coffrefort.fr or by the international patent application W0057279, are proposed to archive all of these electronic or dematerialised documents. On a personal space on a server which generally belong to trustworthy third parties and that are accessible via a large number of terminals (computers, mobile telephone with WAP or Internet connection, etc.) all of the contents required are stored especially those for administrative purposes to avoid having to make copies on a regular basis, for example wage slips, family record books and bank statements (especially with the solution of the virtual dematerialised safe being created by the French government). Some of these solutions permit a certified copy to be subsequently obtained which complies with the original documents stored in the dematerialised safe in order to compile official documents when requested by the government administrations and/or proof in claims or litigations, etc.

These dematerialised safes are only accessible by the holder of the dematerialised safe, possibly by authentication using a security module and, in certain solutions like www.e-coffrefort.fr, the holder may “give power of attorney” to his/her dematerialised safe entirely to a third party, which is to say granting the person the right to read all the documents stored in the dematerialised safe.

By security module, it is meant any memory systems such as chip cards, USB sticks with access data storage means which when read permit the authentication of the holder to authorise or deny the access to a storage zone. In the case of dematerialised safes at present, these security modules authorise or deny the holder the access to the entire dematerialised safe of the holder.

If certain documents stored in the dematerialised safe are not to be read by the third party, but other documents stored in this dematerialised safe are to be shared, the known solution is to recover the documents to be shared and to transmit them using a transmission system such as E mail. The power of attorney may therefore only be used in a limited manner.

### SUMMARY OF THE INVENTION

The invention relates, according to a first aspect, to a management method of dematerialised safes, comprising a step of attributing, for at least one first portion of a secured storage space associated to a first user, access rights to an identified second user, wherein the first portion comprises an exchange space, associated to first and second users and accessible via a secured link when at least one transaction between the first and second users is carried out involving the execution of at least one first action on the contents of the first portion.

The invention is especially based on the segmentation of the secured storage space associated to a user and the management, portion par portion, of the access rights. Each portion of this space may consequently be managed independently and shared or not with another user.

The secured storage space, —or dematerialised safe—further combines the functions of secured archiving for the holder of the dematerialised safe (the first user) and of a bi-univocal secured exchange box on a predetermined portion of the dematerialised safe with a second user. Consequently, the second user does not have access to the documents of the dematerialised safe of the first user that are not addressed to him/her, nor any visibility of these documents.

The exchange space is designed for exchanges between the first and second users. The exchange space is especially reserved for use by the first and second users, for interaction between these users and them alone, with the exception of possible accesses for management reasons by an administrator user.

The exchange box, as a container or storage space, permits an exchange between the two users for whom this exchange box has been created, by executing an action on its contents. Such an action may be the adding, modification, deletion, consultation of contents, etc.

The exchange box is considered as bi-univocal in that it materialises a bi-univocal relationship between two users. It is used for example to materialise a relationship between, on the one hand, a first set of users—for example a set of customer users—comprising the first user and, on the other hand, a second set of users—together called service providers, companies and/or government administrations—comprising the second user.

The exchange box is called secured as it is only accessible via a secured link and in that the exchanges and operations on the contents of this box are only carried out in a secured environment, for example in the secured environment of a trustworthy third party.

Furthermore, the access rights on the portion are granted to users who are clearly identified and must be authenticated to benefit from this, and not to groups of users—groups to which a new user may be added at any time, as is the case for the management systems of files that are usually available in the operating systems of personal computers. It is especially possible to grant such rights a to a single second user, in order to have a secured exchange mode between the first user and the second user and which is exclusively reserved to these two users.

The rights granted by a user to another may furthermore be granted reciprocally or just one way, according to requirements.

Indeed, the access rights attributed to the second user for said predetermined portion are such that said secured exchange box permits a bi-directional exchange between said first user and said second user.

Consequently, the first user has complete control in terms of management rights (sharing, exchanging, etc.) on all of the contents that he/she emits and/or receives from the second user using this first portion.

Advantageously, the management method includes the attribution for at least one other predetermined portion of a dematerialised safe of access rights to at least one other second user, such that said at least one other predetermined portion forms a secured exchange box between said first user and said at least one other second user.

Consequently, the first user has within his/her dematerialised safe several bi-univocal exchange boxes with different second users, wherein certain of these second users may be formed by a community.

According to one embodiment, the method according to the invention comprises in the case of an access request to the first portion made by a user, a step to authenticate this user, especially in order to verify that it is one of the users associated to the first portion and who has access rights on this portion. In this way, the first portion forms a highly secured space, which has a level of security in terms of access identical to that of a safe. Due to this partitioning in the safe, there is no risk of accidental transfer of contents from another portion of the safe.

In particular, according to one variant of embodiment, the different portions of the secured storage space associated to a user are formed by safes, wherein the secured storage space associated to a user thus forms a set of safes or a room of safes specific to this user.

According to one embodiment, the method according to the invention comprises a step to carry out, upon request from a user, a transaction between the first and second users involving the execution of at least one first action on the contents of the first portion, on the condition that the user making the request is authenticated and has the access rights on the first portion to authorise said first action.

A check may be made each time that an action is carried out on a safe, especially in function of the identity of the user requesting that the transaction be carried out.

According to one embodiment of the method according to the invention, the storage space further comprises a second portion, called the private portion, for which the first user has all the access rights and management rights to share elements of the private portion with at least one third user.

According to one embodiment of the method according to the invention, the storage space further comprises a third portion, called the public portion, for which the first user has attributed to a plurality of users access rights comprising at least reading rights.

The first user has at his/her disposal different types of storage space: for shared use (first portion), for private use (second portion) or even public use (third portion). He/she may therefore manage his/her data by associating to each portion a type of use.

According to one embodiment of the method according to the invention, the transaction involves the execution of at least one second action on the contents of another portion of said storage space or another storage space associated to another user.

According to one embodiment of the method according to the invention, the transaction comprises an action to transfer contents from the first portion to another portion of a secured storage space or vice versa.

The invention can be used for the implementation of any type of transaction, including transactions supposing an access to several safes or several portions of a safe. In this case also, each access to a safe is conditioned by the existence of rights which are sufficient to authorise a user to trigger the execution of one or several actions on one or several safes.

The invention relates, according to a second aspect, to a management server of at least one dematerialised safe, comprising means of attributing access rights to attribute, for at least one first portion of a secured storage space associated to a first user, access rights to a second identified user, wherein the first portion forms an exchange space, associated to first and second users and which is accessible via a secured link when at least one transaction is made between the first and second users involving the execution of at least one first action on the contents of the first portion.

The invention relates, according to a third aspect, to a support for storing data comprising a secured storage space associated to a first user, for a first portion for which access rights are attributed to a second identified user, wherein the first portion forms an exchange space, associated to first and second users and which is accessible via a secured link when at least one transaction is made between the first and second users involving the execution of at least one first action on the contents of the first portion.

The invention relates, according to a fourth aspect, to a security module according to the invention associated to a first user to whom a secured storage space is associated, characterised in that it comprises means of storing data providing access to a predetermined portion of said storage space for which access rights are attributed to a second identified user, wherein the first portion forms an exchange space, associated to first and second users and which is accessible via a secured link when at least one transaction is made between the first and second users involving the execution of at least one first action on the contents of the first portion.

According to one embodiment, the security module according to the invention comprises data to access the entire secured storage space.

The advantages described for the method according to the invention may be directly transposed to the server, the storage support and the security module according to the invention.

The invention applies to all sorts of operations and/or processing jobs supposing an exchange via an electronic document.

The security module according to the invention may especially be used to carry out a transaction between first and second users requesting access to said exchange space, especially to carry out a payment transaction.

Another purpose of the invention is a computer program comprising program code instructions to execute the steps of the management method described above when said program is run on a computer.

According to a preferred implementation, the various steps of the method according to the invention are implemented by software or a computer program, wherein this software comprises software instructions designed to be executed by a data processor of a management server for safes and is designed to command the execution of the various steps of this method.

Consequently, the invention also concerns a program that may be executed by a computer or a data processor, wherein this program comprises instructions to command the execution of the steps of a method as mentioned above.

This program may use any programming language, and be in the form of source code, object code, or an intermediate code between source code and object code, such as a partially compiled form, or in any other suitable form.

The invention also concerns an information support that may be read by a computer or data processor, and which comprises instructions for a program such as that described above.

The information support may be any entity or device capable of storing the program. For example, the support may include storage means, such as a ROM, for example a CD ROM or a microelectronic circuit ROM, or even magnetic storage means, for example a floppy disk or a hard disk.

Furthermore, the information support may be a transmissible support such as an electrical or optical signal, which may be supplied via an electrical or optical cable, by radio or by other means. The program according to the invention may be in particular downloaded from an Internet type network.

Alternatively, the information support may be an integrated circuit wherein the program is incorporated, the circuit is adapted to execute or be used in the execution of the method in question.

### BRIEF DESCRIPTION OF THE DRAWINGS

The characteristics and advantages of the invention will become clearer upon reading the following description, provided by way of example, and the figures referring to it which show:

FIG. 1, a simplified diagram of an architecture integrating a dematerialised safe according to the invention,

FIG. 2, a simplified block diagram of a dematerialised safe according to the invention,

FIG. 3, a simplified block diagram of certain processes of use for a dematerialised safe according to the invention,

FIGS. 4a, 4b, and 4c, a graphic interface of a dematerialised safe according to the invention during access to a predetermined portion of said dematerialised safe, respectively during authentication, during access to the entire dematerialised safe and during access to the predetermined portion,

FIG. 5, a graphic interface of a dematerialised safe according to the invention during the presentation of the contents of a predetermined portion of the dematerialised safe,

FIGS. 6a, 6b, 6c, and 6d, a graphic interface of a dematerialised safe according to the invention during an action to deposit contents in a predetermined portion of the dematerialised safe, respectively when selecting the deposit action, when selecting the contents to be deposited, when choosing to sign and/or encrypt the contents to be deposited and the presentation of the contents after deposit.

FIG. 7 illustrates an embodiment of a process running on one or several safes.

### DESCRIPTION OF PREFERRED EMBODIMENTS

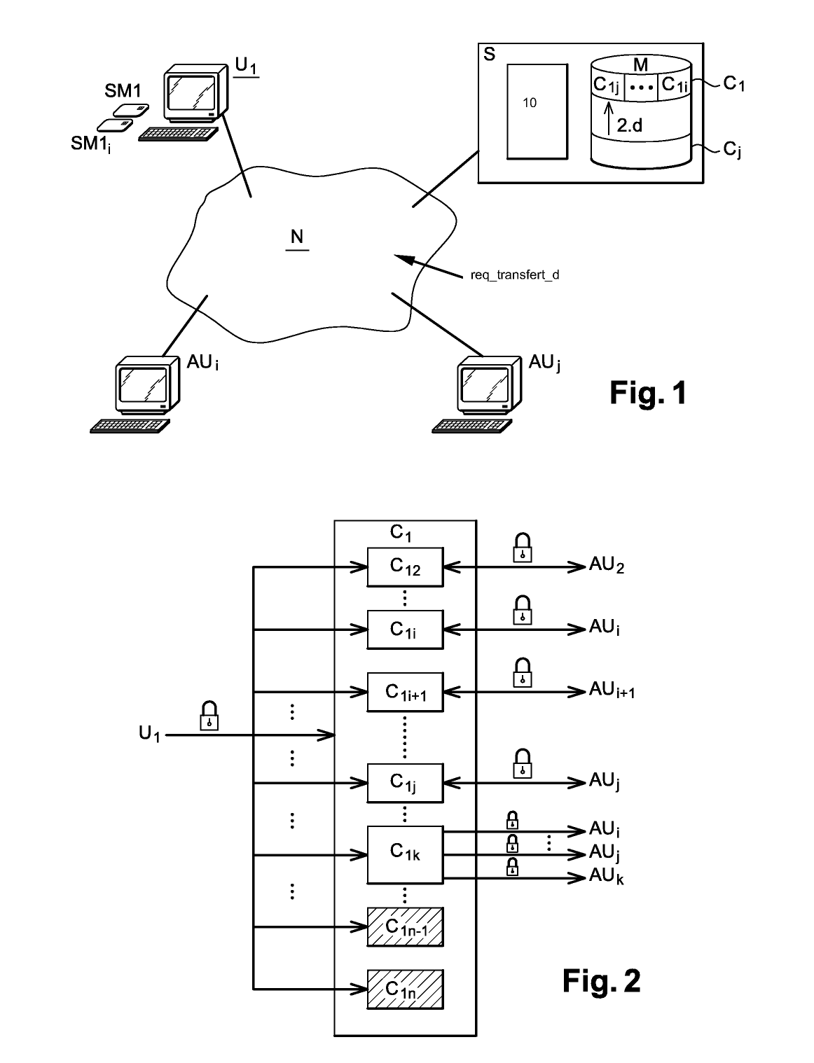

FIG. 1 illustrates an infrastructure in which the dematerialised safes are housed by servers S, especially in bunkers distributed by geographical plate. In the examples of illustrations, the authentication which authorises or denies the access to the dematerialised safe is based on bi-keys (PKI infrastructure with public key and private key) after it has been read in a security module, such as a chip card, a USB stick, a NFC chip, a SIM card of a mobile telephone, a RFID support, etc.

The keys and digital certificates used in these bi-key infrastructures are especially of the X509 type. They further permit the authentication, the signature and the encrypting of the services proposed by the dematerialised safe, which is to say the data composing the program implementing these services. In specific embodiments, the principles of elliptical or factorial cryptography may be used.

In one variant of the invention, the PIN code entered by the user when the key is read for the bi-key authentication could be replaced by a biometrical capture (retina, digital fingerprint, morphology of the face, etc.).

Preferably, for security reasons, strong authentication is used to authenticate a user U1 for the access to a safe C1 which is associated to him/her or to a portion C1i of this safe.

FIG. 1 especially shows a server S comprising a memory M and an interface. The server S forms an access portal to the data stored in memory, an access which is via the interface 10.

The memory M has several heavily dematerialised dematerialised safes C1 . . . Cj. The first user U1 is the holder of the dematerialised safe C1, which is to say that he/she possesses management rights for the dematerialised safe C1 and all of the access rights to this dematerialised safe C1.

When the user U1 wishes to access his/her dematerialised safe C1 using a terminal connected to a network N, he/she authenticates him/herself via the interface 10 of the server S using access data stored in the security module SM1. Consequently, if the authentication is successful, the interface 10 authorises the presentation on the terminal of the user U1 the contents of the dematerialised safe C1. Consequently, the security module SM1 forms an access device per user, which is to say used to authorise the access to the safes associated to a user. In one variant of the invention, when the user U1 wishes to access a predetermined portion C1i of his/her dematerialised safe C1 acting as an exchange box with a second user AUi using a terminal connected to a network N, he/she authenticates him/herself via the interface 10 of the server S using access data stored in the security module SM1i. Consequently, if authentication is successful, the interface 10 authorises the presentation on the terminal of the user U1 the contents of the predetermined portion C1i of the dematerialised safe C1.

In one embodiment of the invention, the user U1 who wishes to access a predetermined portion C1i of his/her dematerialised safe C1 must first access the entire dematerialised safe using the security module SM1 followed by the predetermined portion C1i using the security module SM1i. In another embodiment, the user U1 directly accesses the predetermined portion C1i by simply authenticating him/herself with the dedicated security module SM1i.

The security module SM1i is a device for access by use as the predetermined portion C1i corresponds to a specific use of the dematerialised safe C1, such as the interaction with a second user AUi proposed by C1i, making available publicly the elements proposed by C1k in FIG. 2, private secured archiving proposed by C1n in FIG. 2, etc.

In one variant of the invention, the server S comprises several dematerialised safes, and another second user AUj has a dematerialised safe Cj for which he/she is the first user; the user AUj is able to request the transfer of contents “reg_transfer_d” from his/her dematerialised safe to another dematerialised safe C1 on the server S wherein a predetermined portion C1j forms a secured exchange box between the first user U1 holder, dematerialised safe C1 and the other second user AUj (illustrated by the arrow 1 of FIG. 1). The interface 10 will then transfer the contents d of the dematerialised safe Cj to the predetermined portion C1j of the dematerialised safe C1 as illustrated by the arrow 2 in FIG. 1.

The transfer is only executed if the user holder of the safe to whom the data is addressed has granted sufficient rights to the user holder of the source safe, especially if these rights are sufficient to access in read mode the contents to be transferred.

The invention permits the implementation of a simple and safe multi user exchange method with users who have different, profiles (companies, individuals, administrations, etc.). The transmissions between the of the various different users U1, AUi, AUj and the dematerialised safes on the server S are secured, for example by encrypting all of the data transmitted as is illustrated in FIG. 2 and/or to use a secured bi-univocal tunnel between the user (his/her terminal or a server of the company) and the dematerialised safe such as HTTPS or a VPN or VPN SSL tunnel and/or signature and/or integrity.

Consequently, the invention permits simple private users to have up to date archives without having to worry about the storage, the classification, the durability of contents or the security.

The dematerialised safe C1 of FIG. 2 shows the dematerialised safe as the basis of a secured bi-univocal “multiplex mail box” by predetermined portion. Indeed, the dematerialised safe C1 is broken down into several predetermined portions C12 . . . C1i, C1i+1 . . . . C1j . . . C1 k . . . C1n−1, C1n. All of the dematerialised safe C1 is accessible in reading and writing mode to a first user U1 considered as the holder of the dematerialised safe C1.

Certain predetermined portions C12 . . . . C1i, C1i+1 . . . . C1j of the dematerialised safe C1 are accessible in reading and/or writing mode to a single other user (second user) AU2 . . . AUi, AUi+1 . . . AUj. These predetermined portions C12 . . . AC1, C1i+1 . . . C1j then form bi-univocal and possibly bi-directional exchange boxes as illustrated in FIG. 2, between the first user U1 and the second user respectively AU2 . . . AUi, AUi+1 . . . AUj. in this type of bi-univocal exchange, the first user stores in his/her dematerialised safe for example identification data: bank card number for example to be read by a merchant second user (the reading rights are only granted during a purchase for the duration of the transaction) either manually by the first user, or automatically by the dematerialised safe in reaction to a purchase order emitted by the first user, personal biometric data, medical files accessible to all hospitals forming a second user, etc.

Such a bi-univocal exchange box thus permits the implementation of a payment transaction by Internet. In such a situation the access card SM1i in the portion C1i of the safe C1 may be used as a payment card, authenticating the user making the payment transaction via one or several documents deposited in this portion of the safe. It is however different from a classic bank card in that it does not necessarily permit a withdrawal to be made from an automatic cash dispenser or a payment in a shop. It may only be used as a payment card by the C1i portion of the safe C1. This payment solution has an increased level of security, especially in the event of theft, this card may not be used by another person, who does not know the associated code, to make a classic payment by Internet.

In one variant of the invention, the other users of several predetermined portions, for example C1i and C1i+1, are a sole and same user AUi authorised to access the portions C1i and C1i+1 in reading and/or writing mode thus forming several bi-univocal exchange boxes between the first user U1 and the second user AUi. Consequently, the boxes may be dedicated to specific exchanges: the C1i box for exchanges related to contract(s) between the first user U1 and the second user AUi (where the second user AUi is for example an insurance company), and the exchange box C1i+1 for exchanges between the first user U1 and the second user AUi related to request(s) for compensation by the first user U1 from the second user AUi.

Certain predetermined portions C1 k of the dematerialised safe C1 are accessible in reading mode solely to several other users (other second users) AUi, AUj and AUk. These predetermined portions C1k of the dematerialised safe C1 then form a public consultation box (in which the first user stores or archives proof of his/her address for example).

The dematerialised safe C1 nevertheless conserves in the example of FIG. 2 predetermined portions C1n−1, C1 n accessible solely by the holder U1 who possibly has the management rights in addition to the access rights. These predetermined portions C1 n−1, C1 n form the private predetermined portions of the dematerialised safe C1.

The contents deposited in these different predetermined portions of the dematerialised safe C1 are stored by the first user U1 and, possibly by a second user in one of these predetermined portions for which he/she is authorised. If the contents are simply stored, the first user U1 has the complete management of them, which is to say that apart from the rights to deposit contents, he/she has the right to modify and destroy them. in one variant of the invention, certain contents are archived which is to say stored with prohibition to modify or destroy them during a predetermined period of time which forms the archive duration for example for contents such as bank statements for 10 years. Depending on the embodiments of the invention, the depositor (first user U1 or second user AUi) chooses to deposit contents in the archive mode, the first user U1 archives certain of the contents stored in the dematerialised safe C1, the dematerialised safe C1 identifies certain contents of his/her deposit as needing to be archived (using for example means of identification of the type of contents). During archiving, respectively of the deposit, the first user or the dematerialised safe C1 indicates the archiving duration of the contents to be archived. For example, the dematerialised safe C1 consults, after identification of the type of contents, an archive duration table which associates a type of content with an archive duration by reading for the type de contents identified the associated archive duration.

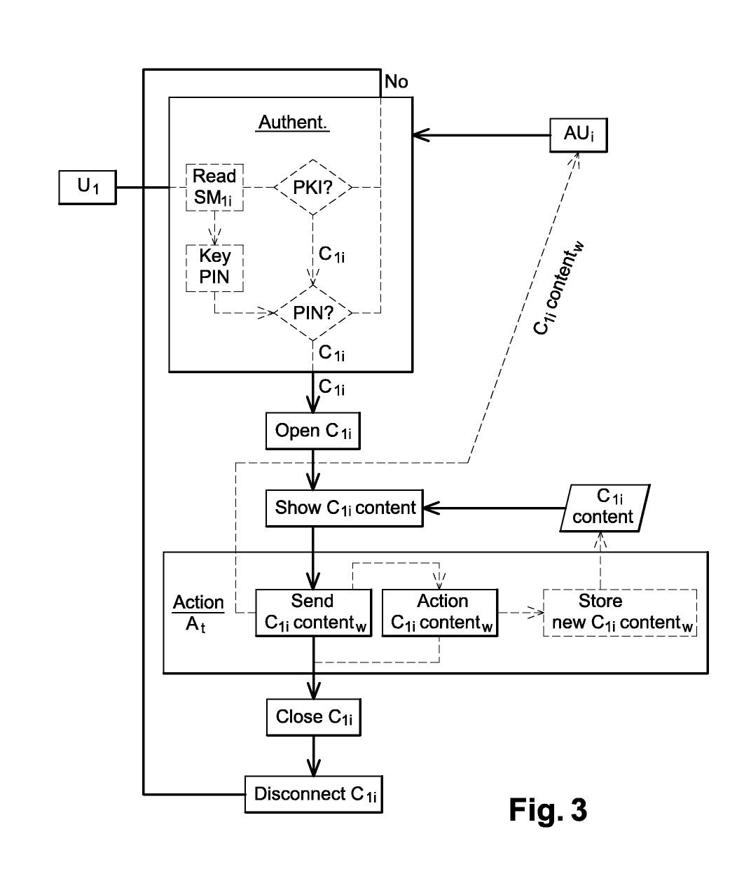

FIG. 3 illustrates the use of the predetermined portion C1i of the dematerialised safe C1 of FIG. 2.

The holder U1 wishing to carry out an action At on the contents of this predetermined portion C1i of the dematerialised safe C1, may authenticate him/herself [Authent] possibly by PKI verification [PKI?] (Authentication by bi key) following the reading of access data on a specific security module SM1i [read SM1i] and/or verification of a PIN code [PIN?] following its entry [Key PIN]. If the authentication fails, the access authorisation is denied and the first user U1 must start his/her authentication again. After successful authentication, the user 111 is authorised to access the predetermined portion C1i of the dematerialised safe C1 and a link is established between the first user U1 and the predetermined portion C1i of the dematerialised safe C1 [Open C1i] for example by opening a VPN tunnel.

In one specific embodiment of the verification by bi-key, the structure implemented is a structure that complies with the standards Pris v2 and X509 v3.

All of the contents of the predetermined portion C1i of the dematerialised safe C1 are then presented to first user U1 [Show C1i content] in order to allow the first user U1 to carry out an action on them all [Action At]. FIG. 3 shows two examples of types of actions At: the transmission of a content to another user [Send C1i contentₑₛ] and an action on the contents themselves: creation, modification, consultation, printing, destruction, etc. [Action/C1i content,]. The transmission of contents to another user AUi is, for example, made by opening an email which has the contents attached. Consequently, the other user AUj does not necessarily possess a dematerialised safe required in the case of the transfer illustrated in FIG. 1. If the action on the contents modifies them (for example creation of contents, deposit, modification, etc.), the action is completed by saving the modified contents in the predetermined portion C1i of the dematerialised safe C1 [Store new C1i content,].

In one variant of the invention, all modifications to contents are saved and dated so that the holder of the dematerialised safe has an exact and conclusive history of the modifications.

Even if it is not shown in FIG. 3, during an access session of a first user U1 to his/her dematerialised safe C1 or to a predetermined portion C1i of his/her dematerialised safe, the user may carry out several actions. Closing the predetermined portion C1i of the dematerialised safe C1 leads to the disconnection of the first user U1 who then needs to be authenticated again when he/she wishes to access this predetermined portion C1i of the dematerialised safe C1 again.

Similarly, the second user AUi who has access to this predetermined portion C1i of the dematerialised safe C1 and who wishes to carry out an action At on the contents of this predetermined portion C1i of the dematerialised safe C1, is authenticated [Authent] and proceeds to carry out the steps described above. The authentication in the case of another user may be made using a specific identification application API consequently permitting an organisation to automate actions on the dematerialised safes of several distinct users where they have secured exchange boxes (For example, a company wishing to deposit the wage slips of its employees in their personal dematerialised safes).

For example, each of the users may request the execution of a process involving the execution of a plurality of actions on one or several portions of one or several safes. In this case also, the rights attributed on these portions to the user requesting that this process be executed must also permit access to these portions so that these actions may be carried out.

In the case of the public consultation box C1 k of FIG. 2, one embodiment of the invention includes the consultation by another second user AUk without authentication, wherein this user AUk only has reading access rights to this public consultation box.

The interfaces of the first user U1 and/or of the second user AUi with the dematerialised safe C1 are, in one variant of the invention, composed of a customer interface, for example in the form of a customer application implemented by a computer program and its complement the interface 10 shown in FIG. 1.

The following figures illustrate a variant of the invention in which, the interface is composed of a communication interface, for example an Internet browser on the customer side and an Internet communication interface on the server side, and the interface 10 of the dematerialised safe C1 solely on the server side. In this case, the interface 10 transmits the data required for the graphic presentation in the Internet browser upon interaction of the first user U1 on dematerialised safe C1. This data is temporarily copied either directly in the terminal of the first user U1 or in the proxy of the terminal. Consequently, a same first user U1 may access his/her dematerialised safe from any terminal connected to the network N to which the server S comprising his/her dematerialised safe C1 is linked.

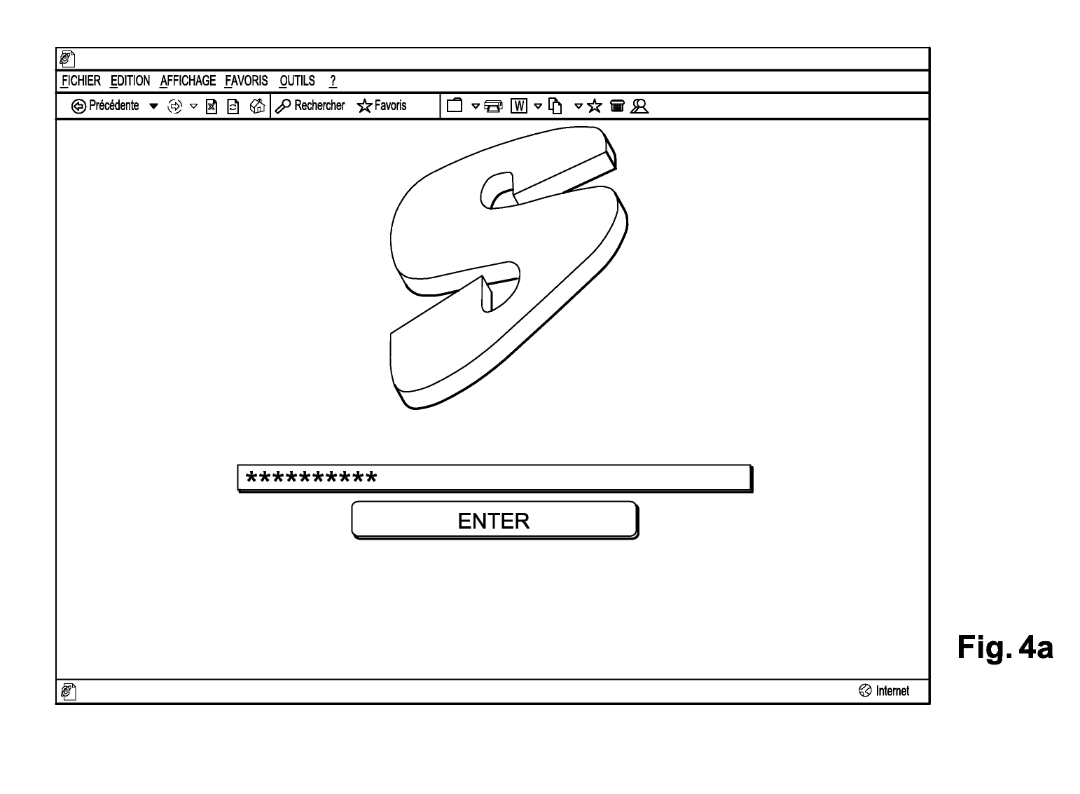

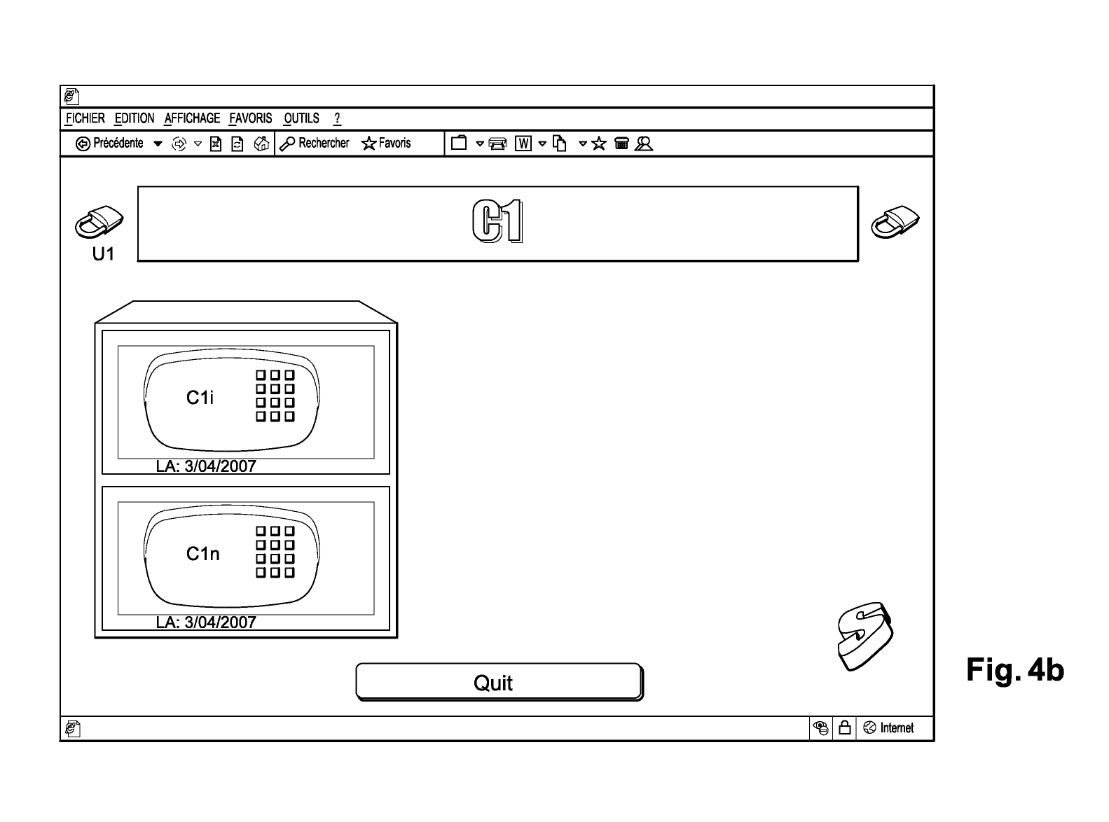

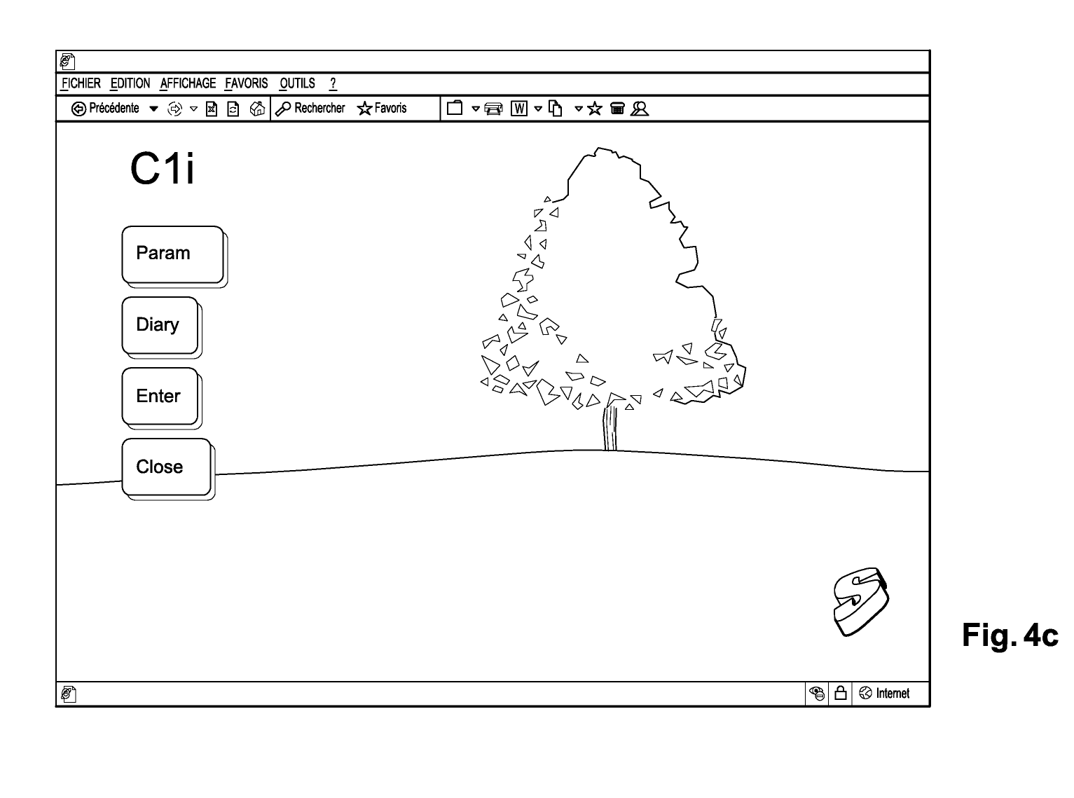

FIG. 4a shows the home page of the server S for access to a dematerialised safe, a page on which the first user U1 enters his/her pass word or PIN code to carry out the authentication which will authorise or deny access to the first user U1 to his/her dematerialised safe C1. In one specific embodiment, the first user U1 will only be authorised to enter his/her PIN code after the reading of a security module SM1 indicating that the holder of the security module SM1 has the right to access the dematerialised safe C1 as the holder of this dematerialised safe C1, which means in out our example that he/she has the reading and writing rights for the entire dematerialised safe C1 and the management rights for the predetermined portions of the dematerialised safe C1 which are not predetermined portions forming pre-established exchange boxes.

Indeed, depending on the variants of the invention, the management rights are shared between the administrator of the server and the first user U1, which is to say the holder, of the dematerialised safe C1 or solely attributed to the first user U1.

In the first variant, the administrator has the right at the time of creation of a dematerialised safe C1 to create predetermined portions for which he/she grants rights of access to second users AUi, AUj, AUk so that these predetermined portions form exchange boxes between the first user U1 and the second users AUi, AUj, AUk. In this first variant, the first user U1 has management rights that are more or less restricted as they are composed of a single, a combination or all of the following rights listed non exhaustively:
creation of directory,
authorisation or not to use access rights for one or several second users AUi,
allocation or not of access rights (reading and/or writing) to one or several other second users AUi+1 on one or several predetermined portions of the dematerialised safe C1 such that the predetermined portions form exchange boxes with the other second user(s) AUi+1.

By authorisation of the use of access rights of a second user AUi it is meant that a predetermined portion C1i has been created with access rights for a specific second user AUi by the administrator who generated the dematerialised safe C1 of the first user U1, wherein the first user U1 has the possibility of granting or not these access rights to this second user AU but not to other second users AUj for this predetermined portion C1i.

By default, the access rights granted to the second user AUi are granted or not depending on a selection made by the administrator.

Reciprocally, the user AUi with whom the portion C1i is shared may furthermore also have management rights on this portion, to attribute or not certain access rights to the user U1.

The access rights that may be attributed by a user to another user especially comprise:

reading or writing rights;

deletion or addition rights;

modification rights.

These rights concern all of the contents, present or future, of the portion for which they are attributed

Preferably however, as the portion AUi is shared, the access rights attributed to the user U1, respectively AUi, are limited, especially so that the user U1 may not destroy or move contents deposited in this space by the user AUi or vice-versa, but solely consult or copy them. In this case, the management rights attributed to the user U1, respectively AUi are also limited to the attribution of a predetermined sub-set of the entire access rights.

Optionally, it is possible for an access right to be granted conditionally on the authorisation of the user manager granting this right on this portion: In this case, an authorisation request is sent to the user manager before carrying out the action concerned, for example before making a modification. In this way, fine management of the access to the contents of a safe is possible.

Furthermore, one of the users U1, AUi associated to this portion C1i, may attribute access rights to another user, to whom this portion is not associated. The space defined by the portion C1i remains therefore reserved to these users.

Preferably, as soon as the portion C1i is created, the access rights are attributed by default to the associated users by a user administrator.

Consequently, any dematerialised safes managed by the administrator may comprise a predetermined portion C1i forming an exchange box with the same second user AUi as it is common to a large number of persons (banks, electricity distributors, etc. . . . ) and each first user U1 is free to choose whether to receive the contents from this second user AUi in dematerialised form in the predetermined portion C1i of his/her dematerialised safe forming an exchange box with the second user AUi by granting the access rights provided by the administrator for this second user AUi or to refuse the dematerialised contents from this second user AUi (for example because he/she wishes to continue to receive the paper document) by granting the access rights provided by the administrator for this second user AUi.

Furthermore, the dematerialised safe according to the invention consequently prohibits multi user interactions at the level of the dematerialised safe. Indeed, either the first user U1 archives for his/her personal requirements in the predetermined portions of the dematerialised safe forming privates boxes C1n, or the first user U1 exchanges with a second user AUi bi-univocally and possibly bi-directionally in a predetermined portion of the dematerialised safe forming an exchange box C1i with this second user AUi, or the first user makes available contents to several second AUi, AUj and/or other second users in a predetermined portion of the dematerialised safe forming a public box C1k in a manner that is equivalent to a subscriber multicast broadcast.

According to one embodiment, said rights granted by a first user to a second user on a predetermined portion of a safe or when sharing a directory or a document of a portion are limited in time and/or limited to a given use:
these rights are granted for a predetermined period of time or for a given date; this means that the action(s) for which these rights were granted may only be executed during this period of time or at this date; and/or
these rights are granted solely for the execution of a predetermined maximum number of times for the action(s) for which these rights were granted; this means for example a single reading/writing operation for contents could be carried out or that only a limited number of files could be read or saved in the portion of the safe for which the rights were granted (example: deposit each month of a wage slip by a company in the safe shared with a user); and/or
these rights are granted solely for the execution of the action(s) for which these rights were granted, as part of a predetermined process; this means for example that the writing/reading access to a portion d'un safe is only authorised for one or several identified process selected beforehand by the user or the administrator who have adequate management rights on the safe concerned.

These processes correspond for example to one or several basic transactions or services or to a complex transaction or service. The transactions or services that a user may trigger are proposed to him/her by a user interface, for example in the form of a list. The user simply selects a transaction from those proposed and triggers it so that it is then executed automatically.

FIG. 4b shows the graphic interface when the first user U1 is authorised to access the dematerialised safe C1. This interface presents the contents of the dematerialised safe C1 which is to say, in our example, two predetermined portions C1i and C1 n: wherein the predetermined portion C1i forms an exchange box with a second user AUi and the predetermined portion C1n is a predetermined private portion to which only the first user U1 has access. In our example of embodiment, the last LA access to each predetermined portion C1i and C1n is shown.

If the first user U1 selects the predetermined portion C1i, the interface 10 sends the corresponding data to the page presented in FIG. 4c. The page proposes the first user U1 different actions related to this predetermined portion C1i: to change the management parameters of this predetermined portion C1i [Param], to view the diary of this predetermined portion C1i [Diary], to enter it [Enter] or to return to the previous page [Close].

In one specific embodiment, any action At on contents of the dematerialised safe C1 is time dated: date of the deposit, date of modification, etc. The diary [Diary] that may be consulted in FIG. 4c provides the history of the actions At on the contents of the predetermined portion C1i based on the dates provided by this time dating.

In one specific embodiment combined or not with the previous embodiment, any contents deposited will be certified. Consequently, when consulting, printing, etc. contents of the dematerialised safe, the dematerialised safe C1 is able to verify the integrity of the contents consulted, printed, etc. with respect to these same contents when emitted by the depositor and to provide an indication of this integrity.

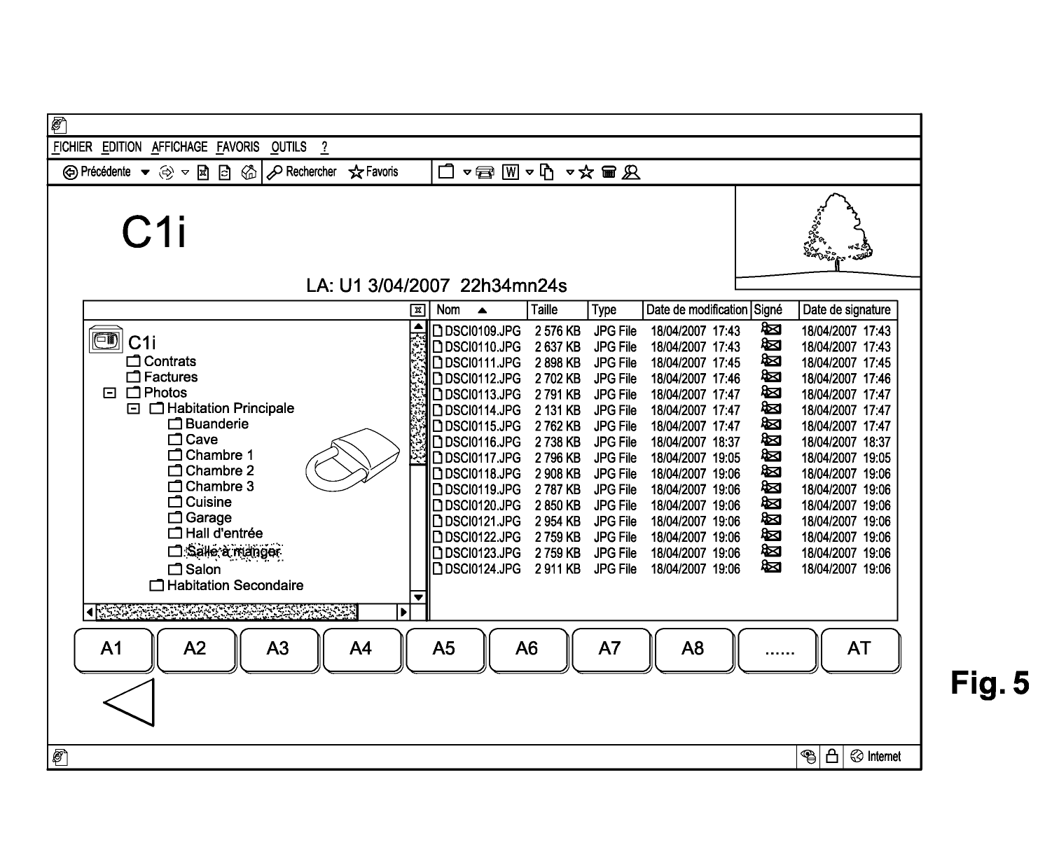

If the first user U1 chooses to enter, especially by clicking on the graphic button “Enter”, either the authentication made by the first user U1 when entering into the dematerialised safe C1 is considered as sufficient, or the a specific authentication is requested from the first user U1 possibly by reading another security module SM1i indicating the access rights to the predetermined portion CU of the holder of the security module SM1i in this case the first user U1. When the access is authorised, the graphic interface permits the first user U1 to view the contents of this predetermined portion C1i as shown by FIG. 5.

In one variant of the invention, this authentication is made when the first user U1 selects the predetermined portion C1i on the graphic interface presented by FIG. 4b. Then the action of entering into the graphic interface of FIG. 4c permits the first user U1 to view the contents of this predetermined portion C1i as shown by FIG. 5.

The contents of the predetermined portion C1i are composed in our example of a tree of directories including various contents such as all types of documents: audio, images, video, texts, etc., of all formats (jpeg, doc, ppt, pps, etc.), compressed (regardless of the type of compression) or not. The graphic interface may indicate the last LA access to this predetermined portion C1i, and/or the date of modification of each document, and/or the date of signature if the contents have been signed, etc. The graphic interface further proposes the first user U1 one or several actions A1, . . . , AT on this predetermined portion C1i of the safe Ci such as one or several of the following actions:
Deposit a new content:

For example, by surfing through the directories of the dematerialised safe that are open, the first user by means of a control interface (mouse, keyboard, speech command, etc.) selects the directory where the content(s) are to be deposited then browses the directories of the terminal to search the contents, possibly chooses to sign and/or encrypt the content(s) to be deposited, and by means of a return interface (screen, loud speaker, etc.) checks that the content(s) are indeed in the chosen directory;
Sign an existing content:
Encrypt an existing content:

For example, by surfing through the directories of the dematerialised safe that are open, the first user by means of a control interface (mouse, keyboard, speech command, etc.) selects the content(s), possibly selects for each content to sign and/or encrypt the content(s) to be deposited by clicking on sign and/or encrypt, and by means of a return interface (screen, loud speaker, etc.) checks that the content(s) chosen are signed and or encrypted (an icon appears highlighting for each document the date(s) of the signature and/or encrypting operations;
Remove an existing content:

For example, by surfing through the directories of the dematerialised safe that are open, the first user by means of a control interface (mouse, keyboard, speech command, etc.) selects the content(s) to be removed and indicates his/her withdrawal selection by clicking on “Remove” then possibly by validating the withdrawal;
Print an existing content:

For example, by surfing through the directories of the dematerialised safe that are open, the first user by means of a control interface (mouse, keyboard, speech command, etc.) selects the content(s) to be printed and indicates his/her print choice by clicking on “Print” then possibly by validating the type of printer and/or the print options chosen;
Move in this predetermined portion C1i an existing content,

For example, by surfing through the directories of the dematerialised safe that are open, the first user by means of a control interface (mouse, keyboard, speech command, etc.) selects the content(s) to be moved, the target directory, selects the option copy or paste then possibly by validating the choice;
Move an existing content in the dematerialised safe C1,
View an existing content,

For example, by surfing through the directories of the dematerialised safe that are open, the first user by means of a control interface (mouse, keyboard, speech command, etc.) selects the content(s) to be viewed, and clicks on “View” (vertical and/or horizontal elevators may permit the navigation in the contents);
Send a third party an existing content,

For example, by surfing through the directories of the dematerialised safe that are open, the first user by means of a control interface (mouse, keyboard, speech command, etc.) selects the content(s) to be sent, the target directory, indicates his/her choice to send the contents by clicking on “Send” and the addressees possibly using a dialogue box which was opened by the choice to send and in which, in one specific embodiment of the invention, the first user may enter an accompanying message, which will be sent by e-mail, SMS, etc. In one specific embodiment, a confirmation of receipt will either be returned to the e mail address of the first user, or deposited in the directory of the dematerialised safe containing the contents sent;
Transfer an existing content to another dematerialised safe:

For example, by surfing through the directories of the dematerialised safe that are open, the first user by means of a control interface (mouse, keyboard, speech command, etc.) selects the content(s) to be sent, the target directory and the dematerialised safe to which the contents are to be transferred, indicates his/her choice to transfer the content(s) by clicking on “Transfer”, in one specific embodiment of the transfer according to the invention, a validation request for the dematerialised safe to dematerialised safe transfer will be made to the holder of the issuing dematerialised safe and/or the holder of the receiving dematerialised safe, in one specific embodiment of the transfer according to the invention, a transfer report may also be presented; such a transfer may therefore be triggered by the holder of the issuing dematerialised safe or by that of the receiving dematerialised safe.
Share a directory or a document with another second user AUi+1:

For example, by surfing through the directories of the dematerialised safe that are open, the first user by means of a control interface (mouse, keyboard, speech command, etc.) selects the content(s) to be sent, the target directory and the person or persons with whom he/she is sharing the contents especially by entering their code, indicates his/her choice to share the contents by clicking on “Share”, in one specific embodiment of the sharing according to the invention, a list of the contents shared could also be presented. These contents shared are dynamic and may be cancelled at any time;

Etc.

The actions proposed to the user on the portion C1i of the safe are therefore either actions requesting access to a single portion of a safe C1, or operations requesting access to at least one other portion of a safe, whether this safe is the safe C1 or another safe.

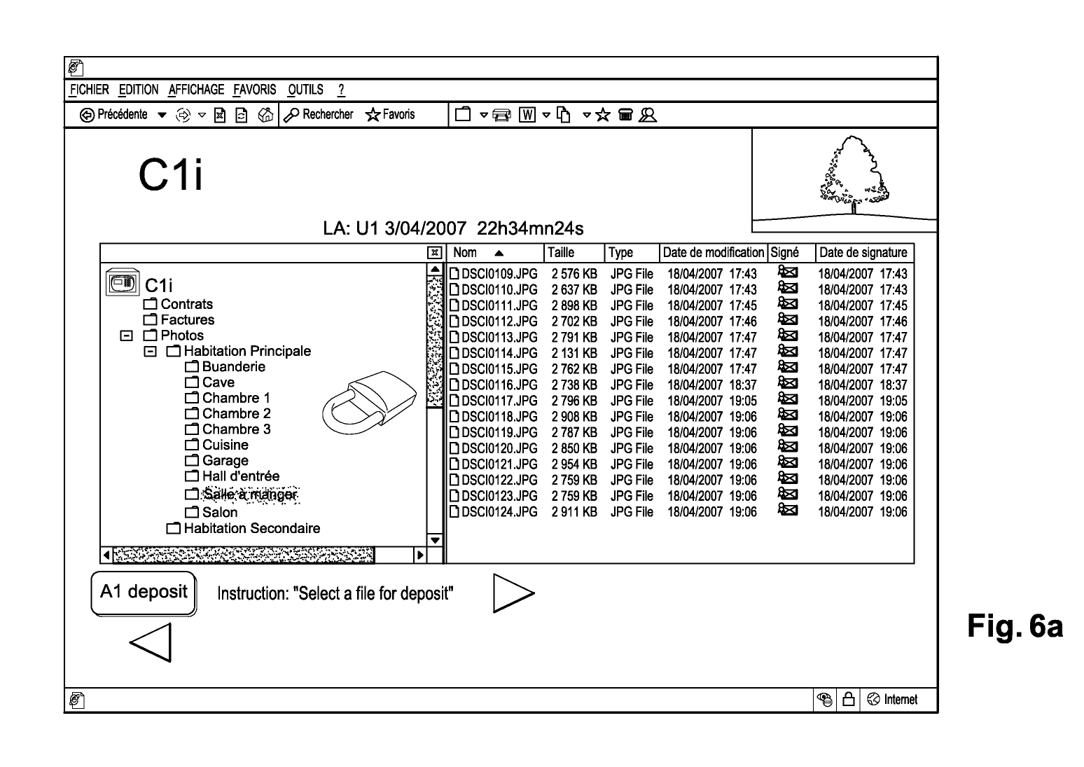

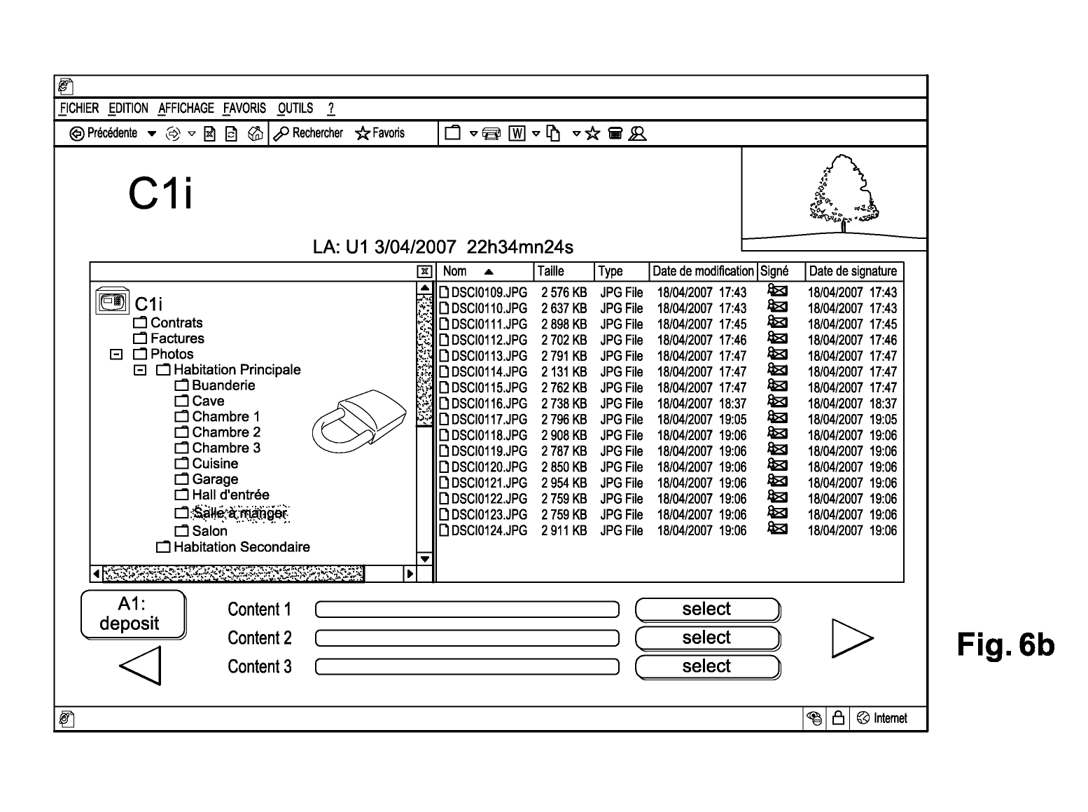

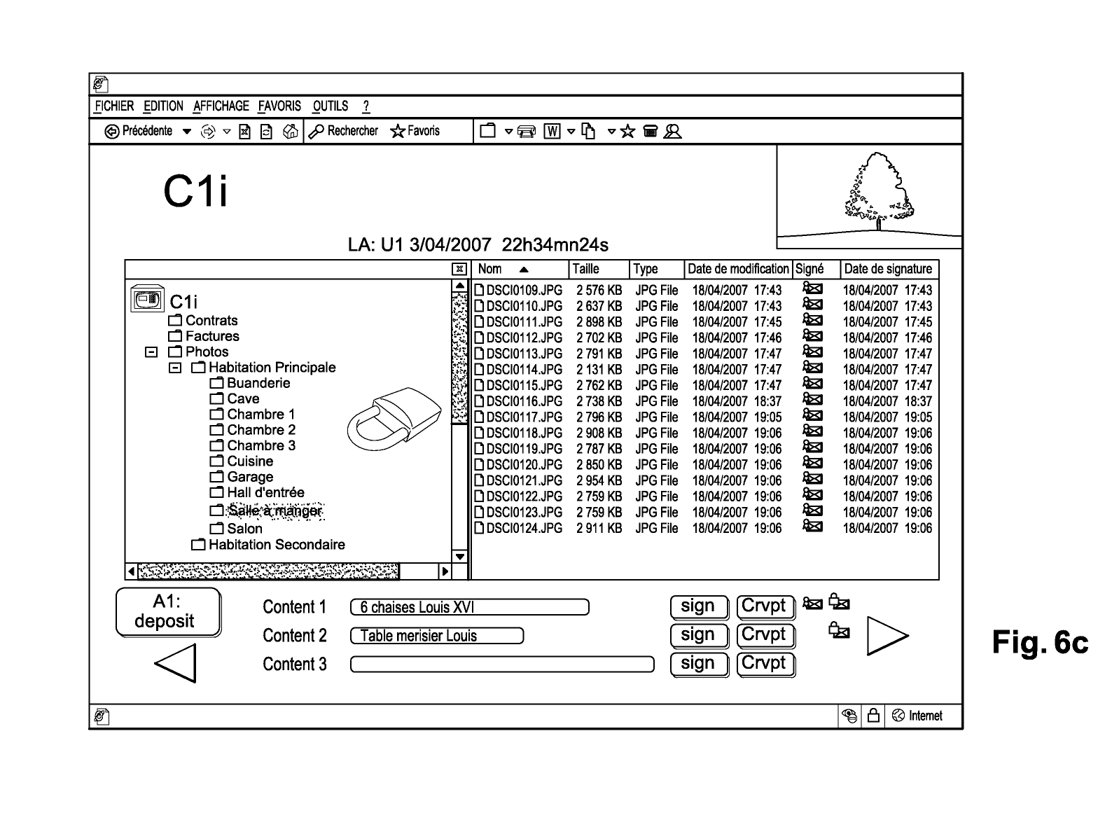

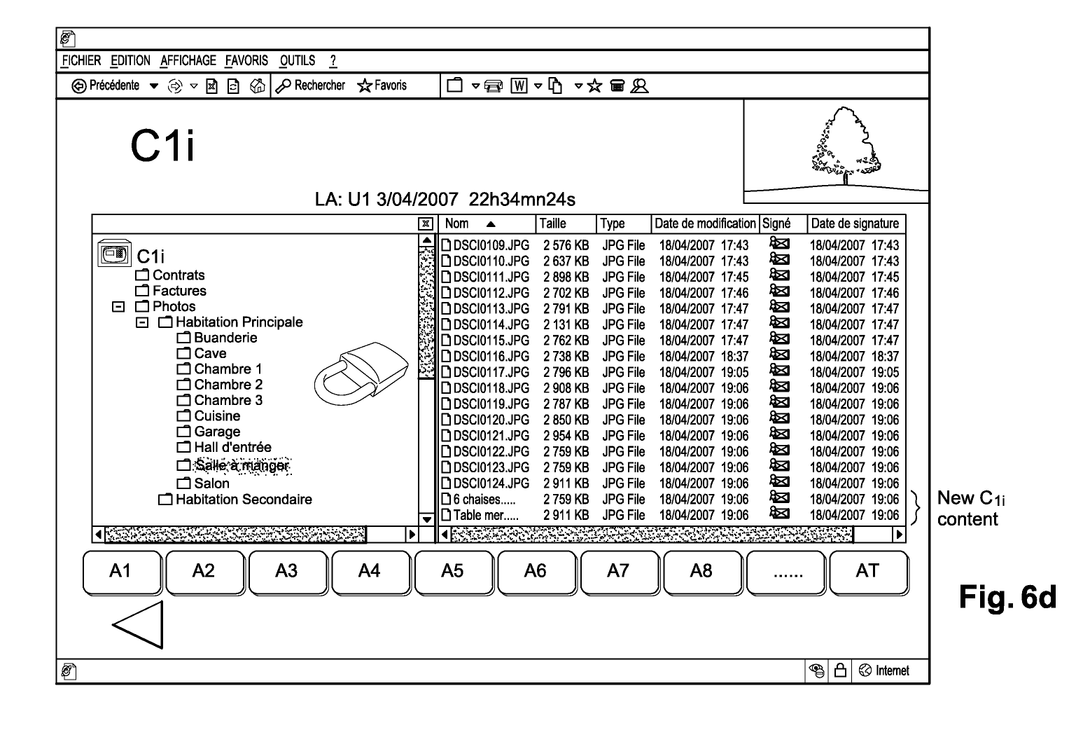

If the first user chooses to make a deposit as shown by the FIGS. 6a à 6d, for example by clicking on a button A1 “deposit” the graphic interface proposes the first user U1 to select [select] the content(s) Content 1, Content 2, Content 3 that he/she wishes to deposit in this predetermined portion C1i of the dematerialised safe C1 as illustrated in FIG. 6a.

In one specific embodiment of the deposit by the first user U1, respectively the second user AUi, in a predetermined portion C1i of a dematerialised safe C1 forming an exchange box between the first user U1 and the second user AUi, the second user AUi, respectively the first user U1, is notified of a deposit in this predetermined portion C1i of the dematerialised safe C1. This notification is sent by email, SMS, MMS, telephone notification by voice message, etc. including the indication of a deposit, and/or the denomination of the contents deposited, and/or the type of contents deposited, and/or an extract or a copy of the entire contents deposited, etc. In other specific embodiment of actions (deposit, modification, withdrawal, etc.) on contents of a predetermined portion C1i of a dematerialised safe C1 for which the notification has been parametered either by the administrator or by the first user U1, and possibly by the second user AUi, a notification will be sent in the same way.

In one variant of the invention, when the first user has selected the contents to be deposited, the graphic interface proposes to sign [Sign] and/or to encrypt [Crypt] each content before it is deposited. In one alternative variant, any movement (writing by deposit, modification, etc.) in a dematerialised safe is automatically notarised which is to say certified and dated, and even signed.

In one variant of the dematerialised safe, the volume of the safe dematerialised may be extended in function of requirements.

Whether the first user has chosen to deposit one, certain or all of the contents without signature and non encrypted, one, certain or all of the signed but non encrypted contents, one, certain or all of the contents without signature but encrypted, one, certain or all of the signed and encrypted contents, the contents are transmitted in a secured manner, especially using an Internet https link shown by the padlock at the bottom RH corner of the graphic interface in FIG. 6d, from the terminal of the first user U1 to the predetermined portion C11 of the dematerialised safe C1 on the server S so that they are saved there [New C1i content].

The invention relates to different aspects of the management of safes.

The invention relates to a management method of a dematerialised safe associated to a first user characterised in that it includes the attribution for a predetermined portion of a dematerialised safe of access rights to a second user, such that said predetermined portion forms a secured exchange box between said first user and said second user.

Furthermore, the access rights attributed to the second user for said predetermined portion are such as said secured exchange box permits a bi-directional exchange between said first user and said second user.

Advantageously, the management method includes the attribution for at least one other predetermined portion of a dematerialised safe of access rights to at least one other second user, such that said at least one other predetermined portion forms a secured exchange box between said first user and said at least one other second user.

The invention also relates to a dematerialised safe associated to a first user. The dematerialised safe includes at least one predetermined portion for which the access rights have been attributed to a second user, such that said predetermined portion forms a secured exchange box between said first user and said second user.

The invention further relates to a server comprising several heavily dematerialised dematerialised safes such as those described above, wherein said heavily dematerialised safes may be associated to distinct first users.

The invention finally relates to a security module associated to a first user of a dematerialised safe. The security module comprises means of storing access data to a predetermined portion of a safe dematerialised, wherein said predetermined portion is accessible to a second user such that said predetermined portion forms a secured exchange box between said first user and said second user. According to one embodiment, the access data is access data to the entire dematerialised safe comprising at least one predetermined portion accessible to a second user such that said predetermined portion forms a secured exchange box between said first user and said second user. Consequently, the security module is a pass permitting the first user to access all of the contents of the dematerialised safe.

The invention permits the implementation of all types of transactions between two users or more: payment, transfer of confidential documents to a bank, sending wage slips, compiling loan application files, etc. This may also relate, as illustrated, to simple exchanges or sharing of documents between two users or more.

These transactions are implemented via one or several portions of one or several safes, consequently acting as secured access exchange spaces and reserved to the users associated to this space, for which this space was created and defined in terms of access rights.

The transactions are carried out by a central entity in the form of a server, acting as a trustworthy third party, authenticating the users, securing all of the contents saved in the safes, securing all of the links established between a portion of safe and a device associated to the user, or even between two portions of safes stored, and finally securing the execution itself of the processes which trigger actions on the safes, wherein this execution takes place in the secured environment of the server S acting as a trustworthy third party.

All of the steps required to execute a transaction are therefore reliable and safe.

1. A management method for dematerialised safes, comprising a step for attributing, for at least one first portion of a secured storage space associated to a first user, access rights to an identified second user, wherein the first portion forms an exchange space, associated to first and second users and accessible via a secured link when at least one transaction is carried out between the first and second users involving the execution of at least one first action on the contents of the first portion.

2. The method according to claim 1, comprising a step to authenticate a user requesting access to the first portion.

3. The method according to claim 1, comprising a step to carry out, on request from a user, a transaction between the first and second users involving the execution of at least one first action on the contents of the first portion, on the condition that the user making the request is authenticated and has access rights for the first portion which authorise said first action.

4. The method according to claim 1, wherein said transaction involves the execution of at least one second action on the contents of another portion of said storage space or another storage space associated to another user.

5. The method according to claim 1, wherein said transaction comprises an action to transfer contents from the first portion to another portion of a secured storage space or vice versa.

6. The method according to claim 1, wherein the storage space further comprises a second portion, called the private portion, for which the first user has all of the access rights and management rights to share elements of the private portion with at least one third user.

7. The method according to claim 1, wherein the storage space further comprises a third portion, called the public portion, for which the first user has attributed to a plurality of users access rights comprising at least reading rights.

8. The method according to claim 1, wherein said rights are attributed for a predetermined period of time or for a given date.

9. The method according to claim 1, wherein said rights are attributed for the execution of a predetermined maximum number of times of said action.

10. The method according to claim 1, wherein said rights are attributed to execute a predetermined process.

11. A computer program comprising program code instructions for execution when said computer program is executed on a computer of a step for attributing, for at least one first portion of a secured storage space associated to a first user, access rights to an identified second user, wherein the first portion forms an exchange space, associated to first and second users and accessible via a secured link when at least one transaction is carried out between the first and second users involving the execution of at least one first action on the contents of the first portion.

12. A management server of at least one dematerialised safe, comprising means of attributing access rights to attribute, for at least one first portion of a secured storage space associated to a first user, access rights to a second identified user, wherein the first portion forms an exchange space, associated to first and second users and accessible via a secured link when at least one transaction is carried out between the first and second users involving the execution of at least one first action on the contents of the first portion.

13. A date storage support comprising a secured storage space associated to a first user, for a first portion for which access rights are attributed to a second identified user, wherein the first portion forms an exchange space, associated to first and second users and accessible via a secured link when at least one transaction is carried out between the first and second users involving the execution of at least one first action on the contents of the first portion.

14. A security module associated to a first user to which a secured storage space is associated, characterised in that it comprises means of storing access data in a predetermined portion of said storage space for which access rights are attributed to a second identified user, wherein the first portion forms an exchange space, associated to first and second users and accessible via a secured link when at least one transaction is carried out between the first and second users involving the execution of at least one first action on the contents of the first portion.

15. The security module according to claim 14, characterised in that it comprises data for access to the entire secured storage space.

16. A use of a security module for the carrying out of a transaction between the first and second users requesting access to said exchange space wherein the security module is associated to a first user to which a secured storage space is associated, characterized in that it comprises means for storing access data in a predetermined portion of the storage space for which access rights are attributed to a second identified user, wherein the first portion forms an exchange space, associated to first and second users and accessible via a secured link when at least one transaction is carried out between the first and second users involving the execution of at least one first action on the contents of the first portion.

17. The use according to claim 16 wherein said transaction is a payment transaction.
